(19) United States
(12) Patent Application Publication
(10) Pub. No.: US 2009/0081945 A1
(43) Pub. Date: Mar. 26, 2009

(54) SYNCHRONISED TRANSMISSION BY MEANS OF SATELLITE AND TERRESTRIAL RADIO CHANNELS OF SUBGROUPS OF DATA GROUPS THAT ARE INTENDED FOR RADIO COMMUNICATION TERMINALS

(75) Inventor: Olivier Courseille, Auzeville (FR)

Correspondence Address: FAY SHARPE/LUCENT, 1228 Euclid Avenue, 5th Floor, The Halle Building, Cleveland, OH, 44115-1843, US

(73) Assignee: Alcatel Lucent, Paris (FR)

(21) Appl. No.: 11/993,451

(22) PCT Filed: Sep. 22, 2006
(86) PCT No.: PCT/FR06/50934

§ 371 Date: Feb. 26, 2008

(30) Foreign Application Priority Data
Sep. 23, 2005 (FR) 0552838

(51) Int. Cl. H04H 20/74

(52) U.S. Cl. 455/3.02

(57) ABSTRACT

The invention relates to a control device (D) which is installed in a data transmission control station (SC) of a communication network comprising at least one communication satellite (SA) and terrestrial communication stations (RE) which are used for the wave transmission of data to radio communication terminals (T1-T4) located in the terrestrial radio cells (C1-C8) of the network. The inventive device (D) comprises control means (MC1) which, when groups of data are to be transmitted to radio terminals (T1) located in at least one destination cell (C6), are used to: (i) subdivide the groups into first and second subgroups; (ii) form a first series of first subgroups and a second series of second subgroups; (iii) order the transmission of (a) the first series to the satellite (SA) and (b) the second series to each destination terrestrial station (RE) associated with a destination cell (C6); and (iv) synchronise the respective transmission times of the satellite (SA) and of each destination terrestrial station (RE), such that each of the radio terminals (T1) can receive each first subgroup of a data group that is intended for same for a period of time that is different from that during which it must receive the second subgroup of the same group.

The invention concerns communication networks comprising at least one communication satellite and terrestrial radio communication stations, and to be more precise the transmission of data by radio to fixed or mobile radio communication terminals situated in the terrestrial cells of such networks.

Certain satellite communication networks include communication stations, also called repeaters, responsible for transmitting by radio, in parallel with the satellites, data intended for the radio communication terminals that are situated in the radio cells that they cover. This enables the radio terminals to receive the data that is intended for them, including when they are situated in a shadow area of a satellite.

This mechanism of double transmission in parallel, by satellite and terrestrial means, is used in particular to broadcast radio, data, multimedia and soon television programmes (or content). It is called hybrid transmission.

If the quantity of data to transmit becomes high, for example in the case of broadcasting data representing video images of high quality, the satellites cannot transmit the data unless the total number of programmes to transmit simultaneously is reduced, because their transmission capacities are limited. In this case, if the “supplementary” programme data is transmitted only by the terrestrial radio means, the radio terminals, which are situated in the coverage area of the satellite but not in a cell covered by a repeater, cannot receive those programmes.

To remedy this drawback, it has been proposed to transmit a portion of the data of a programme by the satellite means (or even also by the terrestrial means in the case of hybrid transmission) and the complementary portion by the terrestrial radio means only. If only the first portion is received by the radio terminal, the signal reproduced corresponds to a first level of quality. If both portions are received simultaneously by the radio terminal, the signal reproduced corresponds to a higher level of quality. Only radio terminals that are situated in an area actually covered by the satellite and by a repeater can receive a programme with higher quality. Those which are outside the cells covered by the repeaters can receive only the first level of quality. Simultaneous reception requires the radio terminals to wait until they have received the two complementary portions, in order to synchronize them, for combining them appropriately before they can be used. The drawback of this solution is that the radio terminals must have two receivers to receive the complementary portions broadcast by the satellite and terrestrial radio means, which increases their cost.

No known solution proving entirely satisfactory, an object of the invention is therefore to improve upon this situation.

To this end it proposes a method of transmitting data in a communication network including at least one communication satellite and terrestrial communication stations adapted to transmit data by radio to radio communication terminals situated in terrestrial radio cells.

This method is characterized in that it consists in:
dividing groups of data to be transmitted in cells into first and second subgroups, and
constituting a first sequence of first subgroups and a second sequence of second subgroups, and
having transmitted in at least one destination cell, on the one hand, the first sequence by the satellite and, on the other hand, the second sequence (or even also a portion of the first sequence in the case of hybrid transmission) by each station associated with each destination cell, synchronizing their respective sending times that each terminal situated in a destination cell can receive each first sub-group of a data group that is intended for it during a time period different from that in which it has to receive the second subgroup of the same group.

The method according to the invention can have other features, and in particular, separately or in combination:
the sending times can be synchronized so that each terminal can receive the first and second subgroups of a data group that is intended for it spaced by a chosen time difference;
the first and said second sequences can be transmitted by first and second carriers at different first and second frequencies. In this case, each terminal awaiting first and second subgroups of a data group that is intended for it locks its multifrequency receiver onto the first frequency in order to receive the first subgroup and then, after receiving said first subgroup, locks the receiver onto the second frequency in order to receive the second subgroup;
the terminal can lock its receiver, firstly, to the first frequency at a chosen first time and during a chosen first duration corresponding to the time interval during which it has to receive the first subgroup from the network and, secondly, to the second frequency at a second time, made equal to the first time increased by a chosen time difference, and during a chosen second duration corresponding to the time interval during which it has to receive the second subgroup from the network.

The invention also proposes a control device for a data transmission control station of a communication network including at least one communication satellite (SA) and terrestrial communication stations adapted to transmit data by radio to radio communication terminals situated in terrestrial radio cells.

This device is characterized in that it comprises control means adapted, in the case of groups of data to be transmitted to radio terminals situated in at least one cell called the destination cell:
to divide the groups into first and second subgroups,
to constitute a first sequence of first subgroups and a second sequence of second subgroups,
to instruct the transmission, on the one hand, of the first sequence by the satellite, and, on the other hand, the second sequence (and even also at least a portion of the first sequence in case of hybrid transmission) to each terrestrial station, referred to as the destination station, associated with a destination cell, and
to synchronize the respective sending times of the satellite and each destination terrestrial station so that each of the radio terminals can receive each first subgroup of a data group that is intended for it during a time period different from that in which it has to receive the second subgroup of that same group.

The control device according to the invention can have other features and in particular, separately or in combination:
its control means can be adapted to synchronize the sending times so that each destination terminal can receive the first and second subgroups of a data group that is intended for it spaced by a chosen time difference;
its control means can be adapted to instruct the transmission of the first and second sequences by means of first and second carriers at different frequencies.

The invention also proposes a data transmission control station for a communication network including at least one communication satellite and terrestrial communication stations adapted to transmit data by radio to radio communication terminals situated in terrestrial radio cells of the network, equipped with a control device of the type described hereinabove.

The invention further proposes a multifrequency radio receiver for a communication terminal attached to a communication network including at least one communication satellite and terrestrial communication stations adapted to transmit data by radio to the terminal when it is situated in a terrestrial radio cell of the network.

This receiver is characterized in that it is adapted to receive and process first and second carriers at first and second frequencies, respectively, and comprises control means adapted, in case of awaiting first and second carriers carrying first and second subgroups of a data group that is intended for it, coming from the satellite and from the terrestrial station associated with the cell in which it is situated, to lock its receive frequency onto the first frequency in order to receive the first carrier carrying the first subgroup and then, after receiving said first subgroup, to lock its receive frequency onto the second frequency in order to receive the second carrier carrying the second subgroup.

The control means can also be responsible for locking its receive frequency, firstly, to the first frequency at a chosen first time and during a chosen first duration corresponding to the time interval during which it has to receive the first subgroup from the network and, secondly, to the second frequency at a chosen second time equal to the first time plus the chosen time difference and during a chosen second duration corresponding to the time interval during which it has to receive the second subgroup from said network.

The invention further proposes a radio communication terminal for a communication network including at least one communication satellite and terrestrial communication stations, equipped with a multifrequency radio receiver of the type described hereinabove.

Other features and advantages of the invention will become apparent on reading the following detailed description and examining the appended drawings, in which:

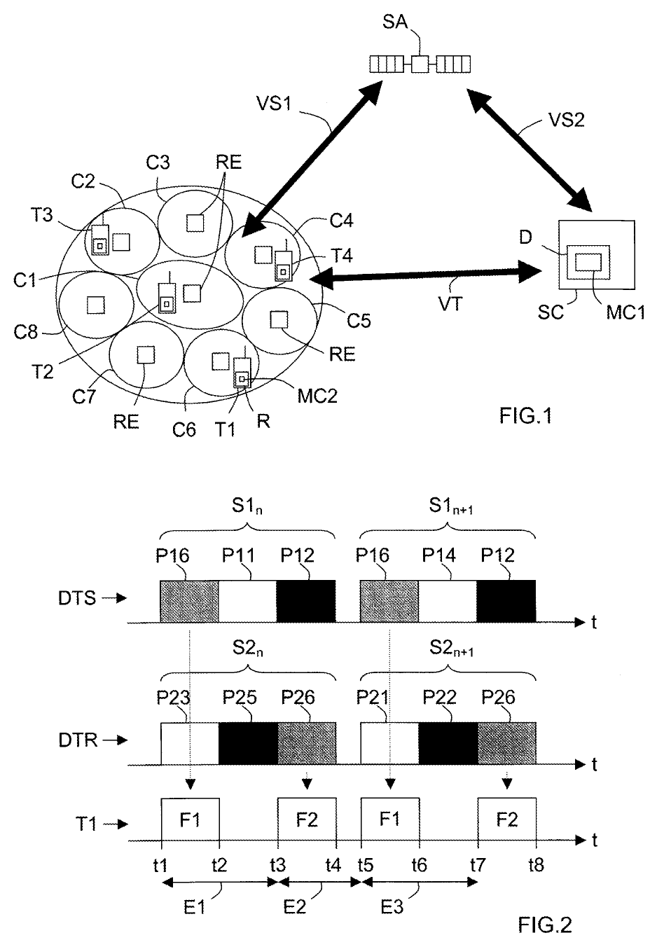

FIG. 1 shows very diagrammatically a portion of a satellite communication network with terrestrial repeaters, comprising a control station equipped with one embodiment of a control device according to the invention and radio communication terminals equipped with multifrequency radio receivers according to the invention, and

FIG. 2 shows diagrammatically one example of a transmission timing diagram of a satellite (DTS), one example of a transmission timing diagram of the terrestrial repeaters of a cell (DTR), and the automatic frequency control as a function of time of a terminal T1 given the transmission diagrams of the satellite and the repeaters of that cell.

The appended drawings constitute part of the description of the invention as well as contributing to the definition of the invention, if necessary.

An object of the invention is to enable fixed or mobile radio communication terminals situated in terrestrial radio cells of a communication network including at least one communication satellite and terrestrial communication stations (or repeaters) to receive large quantities of data (constituting groups), for example television programmes or videos of high quality, or multichannel radio programmes of high quality.

Radio communication terminals (referred to hereinafter as “terminals”) in the form of mobile telephones are considered hereinafter by way of nonlimiting example. However, the invention is not limited to this type of terminal. In fact it concerns all types of terminals provided with a radio receiver able to receive data both by satellite means and by terrestrial means, and in particular fixed or portable computers, television and/or video receivers (for example of the set-top box type), personal audio or video players, and personal digital assistants (PDA).

Moreover, the invention concerns any type of radio transmission, for example that using orthogonal frequency division multiplexing (OFDM).

The network shown in FIG. 1 by way of nonlimiting example comprises a communication satellite SA the beam(s) of which cover(s) a coverage area ZC (satellite channel VS1) and terrestrial communication stations (or repeaters) RE each covering a radio cell Ci situated in the coverage area ZC (terrestrial channel VT). Here the network comprises eight cells C1 to C8 (i=1 to 8). However, the index i can take any value greater than or equal to one (1).

Of course, the network can include one or more satellites covering one or more different coverage areas.

It is important to note that the cells Ci can be divided into sets each forming a single frequency network (SFN), i.e. all synchronously transmitting the same content at the same frequency.

Terminals Tj situated in the coverage area ZC are equipped, in accordance with the invention, with a multifrequency type radio receiver RR the usefulness of which will become clear later. Here “multifrequency radio receiver” means a receiver including in particular a tuner and a demodulator both capable of functioning on one or the other of at least two different carrier frequencies according to the chosen automatic frequency control.

In the example shown in FIG. 1, four terminals T1 to T4 (j=1 to 4) have been represented. However, the index j can take any value greater than or equal to one (1).

The data that is intended for the terminals Tj comes from a data transmission control station SC, also called a satellite gateway. This control station SC is adapted to transmit said data to the satellite SA on another satellite channel VS2 by means of a first modulated carrier at a certain frequency (F3) and to the repeaters RE, by means of a conventional terrestrial or satellite type transmission system. It will be noted that the carriers transmitted by the control station SC to the satellite SA are subjected to a frequency change (F3→F1) in the satellite SA. The terminals Tj therefore receive the data from the satellite SA on a first carrier at the first frequency F1 and the data from the repeaters RE on a second carrier at the second frequency F2.

It will also be noted that the data transmitted to the repeaters RE is not necessarily identical for all the cells Ci.

To be more precise, the control station SC includes a control device D including a control module MC1 responsible for carrying out four operations when groups of data (voluminous and/or of high quality) must be transmitted to terminals Tj that are situated in at least one cell Ci (called the destination cell) of the coverage area ZC.

The first operation consists in dividing the data groups to be transmitted into complementary first subgroups P1i and second subgroups P2i. The first subgroups P1i are intended for all the terminals situated in the coverage area ZC of the satellite SA. They correspond to a first subset of data to be broadcast (for example a video or audio content of lower quality, or certain programmes from a group of programmes). The second subgroups P2i are intended for the terminals Tj that are situated in one or more cells Ci. They correspond to a second subset of data to be broadcast, complementary to the first, enabling a video or audio content of higher quality to be obtained, for example, or other programmes from the group of programmes. The first subgroups P1i and second subgroups P2i together provide all of the data broadcast (for example a video or audio content of higher quality or all the programmes from a group of programmes). The volume of data of the first subgroup P1i broadcast by satellite SA is adapted to the transmission capacity of said satellite SA.

The second operation consists in constructing a first sequence S1 of first subgroups P1i and a second sequence S2 of second subgroups P2i from the first subgroups P1i and the second subgroups P2i obtained during the first operation. The second sequence S2 is not necessarily the same for all the cells Ci.

The third operation consists in instructing the control station SC to transmit the first sequence S1 to the satellite SA and the second sequence S2 to each (so-called destination) repeater RE associated with a destination cell Ci. In the case of hybrid transmission, i.e. if the content transmitted by the satellite SA in its coverage area ZC is also transmitted by the repeaters RE in the cells Ci, the control station SC also transmits the first sequence S1 to the repeaters of the destination cells Ci.

The fourth operation consists in synchronizing the respective sending times of the satellite SA and each destination repeater RE for each cell Ci, so that each destination terminal Tj, situated in a cell Ci, can receive each first subgroup P1i of a data group that is intended for it during a time period different from that during which it must receive the second subgroup P2i of the same group.

A terminal Tj that is the destination of a data group divided into first subgroups P1i and second subgroups P2i is advised by the network of the transmission modalities of the subgroups by the satellite SA and by the repeater RE of the cell Ci in which it is situated.

Consequently, according to the invention, each receiver R installed in a terminal Tj includes a control module MC2 responsible, each time that it is awaiting first and second carriers including first subgroups P1i and second subgroups P2j from a data group that is intended for it, to lock its receive frequency onto the (first) frequency F1 in order to receive the first carrier including the first subgroup P1i. Then, once the receiver has received the first subgroup P1i, its control module MC2 locks its receive frequency onto the (second) frequency F2 in order to receive the second carrier including the second subgroup P2i.

The receiver R therefore functions in a time slicing mode.

In one advantageous embodiment, the network can supply to each terminal Tj that is the destination of a data group divided into first subgroups P1i and second subgroups P2i timing information such as the scheduled start time (t1) of reception of the first subgroup P1i, for example, the (first) duration (or time interval) (t2-t1) scheduled for transmission of that first subgroup P1i (or the scheduled time t2 of the end of reception of the first subgroup P1i), the scheduled time (t3) of starting of reception of the second subgroup P2i (or the difference E1 between t1 and t3), and the (second) duration (or time interval) (t4-t3) scheduled for transmission of this second subgroup P2i (or the scheduled time of end of reception t4 of the second subgroup P2i).

Knowing this timing information, the control module MC2 of the receiver R of a destination terminal Tj can lock its receive frequency onto the first frequency F1 at the time t1 (or just before then to provide a margin) and during the (first) duration t2-t1 (or during a slightly longer duration to provide a margin). The control module MC2 then interrupts automatic frequency control and resumes it in order to lock the receive frequency onto the second frequency F2 at the time t3 (or just before it to provide a margin) and during the (second) duration t4-t3 (or during a slightly greater duration to provide a margin). Once this duration t4-t3 has passed, the control module MC2 interrupts the automatic frequency control again.

FIG. 2 represents diagrammatically, firstly, a diagrammatic example of a send timing diagram DTS of the satellite SA, secondly, an example of a send timing diagram DTR of the destination repeaters RE of the cell C6 (i=6), and, thirdly, the automatic frequency control as a function of time (t) of the terminal T1 that is situated in the cell C6 (i=6), taking account of the sending diagrams DTS and DTR of the satellite SA and of the destination repeaters RE of this cell C6.

In the case of hybrid transmission of the content from the satellite SA, it is considered for simplicity that the associated terrestrial transmission has the same sending timing diagram DTS as the satellite SA. This is not obligatory, however.

In the following description, the content transmitted by the repeaters RE of the various cells Ci is considered to be the same. This is not obligatory, however.

To be more precise, this nonlimiting example considers:
that a first sequence S1ₙ to be transmitted by the satellite SA (DTS) comprises a first three data subgroups P16, P11 and P12 respectively associated with contents Co6, Co1 and Co2 addressed to terminals situated in all or part of the coverage area ZC,
that another first sequence S1ₙ₊₁ to be transmitted by the satellite SA (DTS) after the first sequence S1ₙ also comprises a first three data subgroups P16, P14 and P12 respectively associated with contents Co6, Co4 and Co2 intended for terminals situated in all or part of the coverage area ZC,
that a second sequence S2ₙ to be transmitted (in particular) by the repeater RE (DTR) of the cell C6 includes three second data subgroups P23, P25 and P26 associated with contents Co3, Co5 and Co6, respectively, and
that a second sequence S2ₙ₊₁ to be transmitted (in particular) by the repeater RE (DTR) of the cell C6 after the second sequence S2ₙ comprises three second data subgroups P21, P22 and P26 associated with contents Co1, Co2 and Co6, respectively.

In this case:
the first subgroup P16 of the first sequence S1ₙ transmitted by the satellite SA and the second subgroup P26 of the second sequence S2ₙ transmitted (in particular) by the repeater RE of the cell C6 are obtained by the division of the same data group by the control device D of the control station SC,
the first subgroup P11 of the first sequence S1ₙ transmitted by the satellite SA and the second subgroup P21 of the second sequence S2ₙ₊₁ transmitted in particular by the repeater RE of the cell C6 after the second sequence S2ₙ are obtained by division of the same data group by the control device D of the control station SC,
the first subgroup P12 of the first sequence S1ₙ transmitted by the satellite SA and the second subgroup P22 of the second sequence S2ₙ₊₁ transmitted in particular by the repeater RE of the cell C6 after the second sequence S2ₙ are obtained by dividing the same data group by the control device D of the control station SC,
the first subgroup P16 of the first sequence S1ₙ₊₁ transmitted by the satellite SA after the first sequence S1ₙ and the second subgroup P26 of the second sequence S2ₙ₊₁ transmitted (in particular) by the repeater RE of the cell C6 after the second sequence S2ₙ are obtained by division of the same data group by the control device D of the control station SC,
the first subgroup P14 of the first sequence S1ₙ₊₁ transmitted by the satellite SA is obtained by the division of a subsequent data group effected by the control device D of the control station SC, the complementary second subgroup P24 having to form part of a second sequence (S2ₙ₊₂) that is not shown that has to be transmitted (in particular) by the repeater of the cell C6 after the second sequence S2ₙ₊₁,
the first subgroup P12 of the first sequence S1ₙ₊₁ transmitted by the satellite SA is obtained by the division of a subsequent data group by the control device D of the control station SC, the complementary second subgroup P22 having to form part of a second sequence (S2ₙ₊₂ or S2ₙ₊₃) that is not shown that has to be transmitted (in particular) by the repeater of the cell C6 after the second sequence S2ₙ₊₁,
the second subgroup P23 of the second sequence S2ₙ transmitted (in particular) by the repeater of the cell C6 is obtained by the division of a preceding data group by the control device D of the control station SC, the complementary first subgroup P13 forming part of a first sequence S1ₙ₋₁ that is not shown before the first sequence S1ₙ transmitted by the satellite SA,
the second subgroup P25 of the second sequence S2ₙ transmitted (in particular) by the repeater of the cell C6 is obtained by the division of a preceding data group by the control device D of the control station SC, the complementary first subgroup P15 forming part of a sequence that is not shown before the first sequence S1ₙ transmitted by the satellite SA.

It is important to note that the number of first subgroups P1i that a sequence comprises is not limited to three. It can take any value greater than or equal to two (2). Similarly, the number of second subgroups P2i that a sequence comprises is not limited to three. It can take any value greater than or equal to two (2). Furthermore, the number of first subgroups P1i that a sequence transmitted by a satellite SA (or by the repeaters RE) comprises is not necessarily identical at all times to the number of second subgroups P2i that a sequence transmitted by the repeaters RE (or by a satellite SA) comprises.

It is now considered that the terminal T1 (situated in the cell C6) wishes to receive the content Co6. The control module MC2 of the receiver R of the terminal T1 situated in the cell C6, the automatic frequency control diagram as a function of time (t) is illustrated in the lower portion of FIG. 2, locks the receive frequency onto the first frequency F1 at the time t1 (or just before it to obtain a margin) and for the (first) duration t2-t1 (or for a slightly longer duration to provide a margin). Its receiver R then receives from the satellite SA the first sequence S1ₙ and extracts from it the first subgroup P16 of the content Co6 that it wishes to receive. The control module MC2 then interrupts automatic frequency control at the time t2 (or just after it to provide a margin) and resumes it at the time t3 (or just before it to obtain a margin) in order to lock the receive frequency onto the second frequency F2 and during the (second) duration t4-t3 (or during a very slightly greater duration to provide a margin). Its receiver R then receives from the repeater RE of the cell C6 the second sequence S2ₙ and extracts from it the second subgroup P26 of the content Co6 that it wishes to receive. The control module MC2 then interrupts automatic frequency control at the time t4 (or just after it to obtain a margin).

In order to continue to receive the remainder of the content Co6 (if it so wishes), the receiver of the terminal T1 is alerted by the network, or via information received beforehand, of the transmission of another data group (and of the corresponding timing information [t5, t6, t7, t8, E2=t5−t3, E3=t7−t5]). Its control module MC2 then locks the receive frequency onto the first frequency F1 at the time t5 (or just before it to obtain a margin) and for the (first) duration t6-t5 (or for a very slightly greater duration to obtain a margin). Its receiver R then receives from the satellite SA the first sequence S1ₙ₊₁ and extracts from it the first subgroup P16 that is intended for it (in particular). The control module MC2 then interrupts automatic frequency control at the time t6 (or just before it to obtain a margin) and resumes it at the time t7 (or just before it to obtain a margin) in order to lock the receive frequency onto the second frequency F2 and for the (second) duration t8-t7 (or for a very slightly greater duration to obtain a margin). Its receiver R then receives from the repeater RE from the cell C6 the second sequence S2ₙ₊₁ and extracts from it the second subgroup P26 that is intended for it (in particular). The control module MC2 then interrupts the automatic frequency control at the time t8 (or just after it to obtain a margin).

Knowing the various times t1 to t7 beforehand can enable the terminal to place certain functions linked to reception on standby between the times t2 and t3, t4 and t5, t6 and t7, for example to reduce its electrical power consumption.

The control device D according to the invention, and in particular its control module MC1, and the control module MC2 of a receiver R can be produced in the form of electronic circuits, software (or electronic data processing) modules, or a combination of circuits and software.

A control device D and a multifrequency radio receiver R for implementing the invention have been described hereinabove. However, this invention can also be considered in the form of a data transmission method. This method can be implemented by means of the control device D and the multifrequency radio receivers R described hereinabove. The main and optional functions and sub-functions of the steps of this method being substantially identical to those of the various means constituting the device D and the receivers R, only the steps implementing the main functions of the method according to the invention are summarized hereinafter.

This method consists in:
dividing data groups to be transmitted in at least one destination cell Ci into first subgroups P1i and second subgroups P2i,
constituting a first sequence S1 of first subgroups P1i and a second sequence S2 of second subgroups P2i, and
having transmitted in each destination cell Ci, on the one hand, the first sequence S1 by the satellite SA and, on the other hand, the second sequence S2 by each terrestrial station RE associated with each destination cell Ci, synchronizing their respective sending times so that each destination terminal Tj situated in a destination cell Ci can receive each first sub-group P1i of a data group that is intended for it during a time period different from that in which it has to receive the second subgroup P2i of the same group.

The invention is not limited to the control device, data transmission control station, multifrequency radio receiver, radio communication terminal and data transmission method embodiments described hereinabove by way of example only, but encompasses all variants that the person skilled in the art might envisage within the scope of the following claims.

1. Method of transmitting data in a communication network including at least one communication satellite (SA) and terrestrial communication stations (RE) adapted to transmit by data radio to radio communication terminals (Tj) situated in terrestrial radio cells (Ci) of said network, characterized in that it consists in i) dividing groups of data to be transmitted in at least one destination cell (Ci) into first subgroups (P1i) and second subgroups (P2i),
ii) constituting a first sequence (S1) of first subgroups (P1i) and a second sequence (S2) of second subgroups (P2i), and iii) having transmitted in each destination cell (Ci), on the one hand, the first sequence (S1) by the satellite (SA) and, on the other hand, the second sequence (S2) by each terrestrial station (RE) associated with each destination cell (Ci), synchronizing their respective sending times that each destination terminal (Tj) situated in a destination cell (Ci) can receive each first sub-group (P1i) of a data group that is intended for it during a time period different from that in which it has to receive the second subgroup (P2i) of the same group.

2. Method according to claim 1, characterized in that said sending times are synchronized so that each terminal (Tj) can receive the first subgroups (P1i) and the second subgroups (P2i) of a data group that is intended for it spaced by a chosen time difference.

3. Method according to claim 1, characterized in that said first sequence (S1) and said second sequence (S2) are transmitted by first and second carriers at different first and second frequencies and in that each terminal (Tj) awaiting first subgroups (P1i) and second subgroups (P2i) of a data group that is intended for it locks a multifrequency radio receiver (R) onto said first frequency in order to receive said first subgroup (P1i) and then, after receiving said first subgroup (P1i), locks said receiver (R) onto said second frequency in order to receive said second subgroup (P2i).

4. Method according to claim 2, characterized in that said first sequence (S1) and said second sequence (S2) are transmitted by first and second carriers at different first and second frequencies and in that each terminal (Tj) awaiting first subgroups (P1i) and second subgroups (P2i) of a data group that is intended for it locks a multifrequency radio receiver (R) onto said first frequency in order to receive said first subgroup (P1i) and then, after receiving said first subgroup (P1i) locks said receiver (R) onto said second frequency in order to receive said second subgroup (P2i) and further characterized in that said terminal (Tj) locks its receiver (R) firstly, to said first frequency at a chosen first time and during a chosen first duration corresponding to the time interval during which it has to receive said first subgroup (P1i) from said network and, secondly, to said second frequency at a second time, made equal to the first time increased by a chosen time difference, and during a chosen second duration corresponding to the time interval during which it has to receive said second subgroup (P2i) from said network.

5. Method according to claim 1, characterized in that at least a portion of said first sequence (S1) is transmitted by each station (RE) associated with a destination cell (Ci), synchronizing the sending times of the satellite (SA) and the stations (RE) so that each terminal (Tj) situated in a destination cell (Ci) can receive each first subgroup (P1i) of a data group that is intended for it via said satellite (SA) and via said repeaters (RE) during a time period different from that in which it has to receive from said repeaters (RE) the second subgroup (P2i) of that same group.

6. Control device (D) for a data transmission control station (SC) of a communication network including at least one communication satellite (SA) and terrestrial communication stations (RE) adapted to transmit data by radio to radio communication terminals (Tj) situated in terrestrial radio cells (Ci) of said network, characterized in that it comprises control means (MC1) adapted, in the case of groups of data to be transmitted to radio terminals (Tj) situated in at least one cell called the destination cell (Ci), i) to divide said groups into first subgroups (P1i) and second subgroups (P2i), ii) to constitute a first sequence (S1) of first subgroups (P1i) and a second sequence (S2) of second subgroups (P2i), iii) to instruct the transmission, on the one hand, of said first sequence (S1) to said satellite (SA), and on the other hand, of said second sequence (S2) to each terrestrial station (RE), referred to as the destination station, associated with a destination cell (Ci), and iv) to synchronize the respective sending times of said satellite (SA) and each destination terrestrial station (RE) so that each of said radio terminals (Tj) can receive each first subgroup (P1i) of a data group that is intended for it during a time period different from that in which it has to receive the second subgroup (P2i) of that same group.

7. Device according to claim 6, characterized in that said control means (MC1) are adapted to synchronize said sending times so that each destination terminal (Tj) can receive the first subgroups (P1i) and the second subgroups (P2i) of a data group that is intended for it spaced by a chosen time difference.

8. Device according to claim 6, characterized in that said control means (MC1) are adapted to instruct the transmission of said first sequence (S1) and said second sequence (S2) by means of first and second carriers at different frequencies.

9. Device according to claim 6, characterized in that said control means (MC1) are adapted to instruct said stations (RE) associated with the destination cells (Ci) to transmit at least a portion of said first sequence (S1) and to synchronize the sending times of said satellite (SA) and said stations (RE) so that each terminal (Tj) situated in a destination cell (Ci) can receive each first subgroup (P1i) of a data group that is intended for it via said satellite (SA) and via said repeaters (RE) during a time period different from that in which it has to receive from said repeaters (RE) the second subgroup (P2i) of that same group.

10. Data transmission control station (SC) for a communication network including at least one communication satellite (SA) and terrestrial communication stations (RE) adapted to transmit data by radio to radio communication terminals (Tj) situated in terrestrial radio cells (Ci) of said network, characterized in that it comprises a control device (D) according to any one of claims 6 to 9.

11. Multifrequency radio receiver (R) for a communication terminal (Tj) attached to a communication network including at least one communication satellite (SA) and terrestrial communication stations (RE) adapted to transmit data by radio to said terminal (Tj) when it is situated in a terrestrial radio cell (Ci) of said network, characterized in that it is adapted to receive and process first and second carriers at first and second frequencies, respectively, and comprises control means (MC2) adapted, in case of awaiting first and second carriers carrying first subgroups (P1i) and second subgroups (P2i) of a data group that is intended for it, coming from said satellite (SA) and from the terrestrial station (RE) associated with the cell (Ci) in which it is situated, to lock its receive frequency onto said first frequency in order to receive the first carrier carrying said first subgroup (P1i) and then, after receiving said first subgroup (P1i), to lock its receive frequency onto said second frequency in order to receive the second carrier carrying said second subgroup (P2i).

12. Radio receiver according to claim 11, characterized in that said control means (MC2) are adapted to lock its receive frequency, firstly, to said first frequency at a chosen first time and during a chosen first duration corresponding to the time interval during which it has to receive said first subgroup (P1i) from said network and, secondly, to said second frequency at a chosen second time equal to the first time plus said chosen time difference and during a chosen second duration corresponding to the time interval during which it has to receive said second subgroup (P2i) from said network.

13. Radio communication terminal (Tj) for a communication network including at least one communication satellite (SA) and terrestrial communication stations (RE), characterized in that it comprises a multifrequency radio receiver (R) according to claim 11.
